(19) United States
(12) Patent Application Publication
(10) Pub. No.: US 2007/0230079 A1
(43) Pub. Date: Oct. 4, 2007

(54) Semiconductor device

(75) Inventor: Tetsuo Ashizawa, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/493,656

(22) Filed: Jul. 27, 2006

(30) Foreign Application Priority Data
Mar. 31, 2006 (JP) 2006-098291

(51) Int. Cl. H02H 5/04

(52) U.S. Cl. 361/104

(57) ABSTRACT

A semiconductor device includes: an electrical fuse whose one end is connected to a power source via a switch; an electrical fuse whose one end is connected to ground via a switch; a switch that is connected between the other ends of the electrical fuses and the ground and is selected when the electrical fuses are to be cut; and a first pad and a second pad connected to the one-side ends of the electrical fuses respectively. Cutting electric current is supplied from the first or second pad according to information to be recorded, thereby cutting one of the electrical fuses, so that one-bit information is recorded by the two electrical fuses. This eliminates a need for a latch circuit that holds cut information on the fuses and enables recording and outputting of accurate fuse cut information.

### CROSS-REFERENCE TO RELATED APPLICATIONS

This application is based upon and claims the benefit of priority from the prior Japanese Patent Application No. 2006-098291, filed on Mar. 31, 2006, the entire contents of which are incorporated herein by reference.

### BACKGROUND OF THE INVENTION

1. Field of the Invention

The present invention relates to a semiconductor device having an electrical fuse and recording information according to whether the electrical fuse is cut or not.

2. Description of the Related Art

A fuse is used to record redundant information for relieving a failure cell in a memory, a chip ID for identifying a chip, and the like. At present, an electrical fuse has often been used in place of a conventionally used laser fuse cut by laser blowing.

The electrical fuse here is a fuse that is cut by migration caused by a large amount of electric current passing therethrough. The electrical fuse has the following advantages over the conventional laser fuse.

### (1) The electrical fuse is small in area.

### (2) Even when the electrical fuse is disposed, wiring on an upper layer thereof can be freely used (the laser fuse uses all the layers).

(3) The electrical fuse can be cut while kept placed on a tester. Since a laser blow apparatus is not required for cutting the electrical fuse, time and cost for the test are reduced. The process of “tester (test)→blow apparatus→tester (confirmation)” is required in a case where the laser fuse is used.

### (4) The electrical fuse can be cut even after package assembly.

FIG. 7 is a diagram showing the configuration of a conventional signal generating circuit including electrical fuses and generating control signals according to whether the fuses are cut or not.

In FIG. 7, Fj denotes electrical fuse made of polysilicon, TC1-j, TC2-j, TC3-j, TC4-j, and TC5-j denote transistors, LAj denotes latch circuit, and INVCj denotes inverter. The transistors TC1-j, TC2-j, and TC3-j are used when the fuses are cut and each of them is constituted by a high withstand voltage transistor. “j” is a suffix and j=0, 1, 2.

For cutting the electrical fuse Fj, the transistors TC2-j and TC3-j are turned off by signals SAC, SBC. Further, data DAT for designating the electrical fuse Fj to be cut is supplied to a shift register constituted by latches Lj and operating based on a clock signal CK. Consequently, a signal φCj according to the data DAT is outputted to turn on the transistor TC1-j corresponding to the electrical fuse Fj to be cut.

Applying voltage to a pad PC1 in this state causes electric current to pass through the electrical fuse Fj to be cut and the transistor TC1-j, so that the electrical fuse Fj is blown out by migration.

Further, for reading cut information on the electrical fuse Fj, first, a reset signal RST is set to “L” (low level) at the power-on time to set a node NDj of a latch circuit LAj to “H” (high level). At this time, the transistor TC1-j is OFF and the transistors TC2-j and TC3-j are ON.

Then, after the complete power-on, the reset signal RST is set to “H” to turn off the transistor TC4-j and turn on the transistor TC5-j. Therefore, in a case where the electrical fuse Fj is cut, potential of the node NDj maintains “H”, but in a case where the electrical fuse Fj is not cut, the potential of the node NDj changes to “L” since electric charges are discharged. In this manner, the cut information on the electrical fuse Fj is held in the latch circuit LAj to be outputted via the inverter INVCj.

Japanese Patent Application Laid-open No. Hei 6-124599 describes a control signal generating circuit that includes fuses and is capable of shutting off shoot-through current between power sources, and Japanese Patent Application Laid-open No. 2002-15594 describes an art to electrically detect whether or not fuses have been normally cut.

However, in the conventional circuit as shown in FIG. 7, as processes become more microscopic, resistance against a soft error of the latch circuit LAj holding the cut information on the electrical fuse Fj is becoming lower, which poses a problem of erroneous latch by the latch circuit.

Another problem is that the latch circuits LAj attached to the electrical fuse Fj is large in circuit area. For example, in a case where the redundant information in a RAM macro or the like is recorded, ten-odd fuses are provided per RAM macro. Since a large number of the RAM macros are mounted in a chip and the capacity thereof is increasing more and more, the number of the fuses provided for recording the redundant information is also increasing (for example, 100 to 1000 pieces). Conventionally, since a latch circuit is provided for each fuse as shown in FIG. 7, the total area required for the latch circuits increases.

Further, in order to read the cut information on the electrical fuses Fj, the reset signal RST always has to be externally inputted at the power-on time. The need to input a signal at the power-on time could impose a large restriction on designing.

### SUMMARY OF THE INVENTION

An object of the present invention is to enable recording and outputting information by a fuse without using a latch circuit that holds cut information on the fuse.

A semiconductor device of the present invention includes: a fuse circuit having a first electrical fuse and a second electrical fuse; and a first pad and a second pad supplying the fuse circuit with electric current for cutting the electrical fuses. In the fuse circuit, one end of the first electrical fuse is connected to a first power source via a first switch, one end of the second electrical fuse is connected to a second power source via a second switch, and the other ends of the first and second electrical fuses are connected to a third power source via a cutting switch. Further, the one end of the first electrical fuse is connected to the first pad and the one end of the second electrical fuse is connected to the second pad.

According to the present invention, electric current is supplied from the first or second pad to cut one of the electrical fuses according to information to be recorded, so that one-bit information is recorded by the two electrical fuses.

### BRIEF DESCRIPTION OF THE DRAWINGS

FIG. 1 is a diagram showing a configuration example of a semiconductor device according to a first embodiment of the present invention;

FIG. 2 is a diagram showing another configuration example of the semiconductor device according to the first embodiment of the present invention;

FIG. 3 is a diagram showing a configuration example of a semiconductor device according to a second embodiment of the present invention;

FIG. 4 is a diagram showing another configuration example of the semiconductor device according to the second embodiment of the present invention;

FIG. 5 is a diagram showing still another configuration example of the semiconductor device according to the second embodiment of the present invention;

FIG. 6 is a diagram showing a concrete application example of the semiconductor device according to the embodiment of the present invention; and

FIG. 7 is a conventional signal generating circuit that generates control signals according to whether or not electrical fuses are cut.

### DETAILED DESCRIPTION OF THE PREFERRED EMBODIMENTS

Hereinafter, embodiments of the present invention will be described based on the drawings.

Semiconductor devices according to the embodiments of the present invention to be described below are capable of generating and outputting a signal according to whether electrical fuses are cut or not. Further, in the semiconductor devices according to the embodiments of the present invention, two electrical fuses and two pads corresponding to the two electrical fuses are formed as a unit and one-bit information is recorded by using the two electrical fuses and one of the fuses is selectively cut according to the information to be recorded.

### First Embodiment

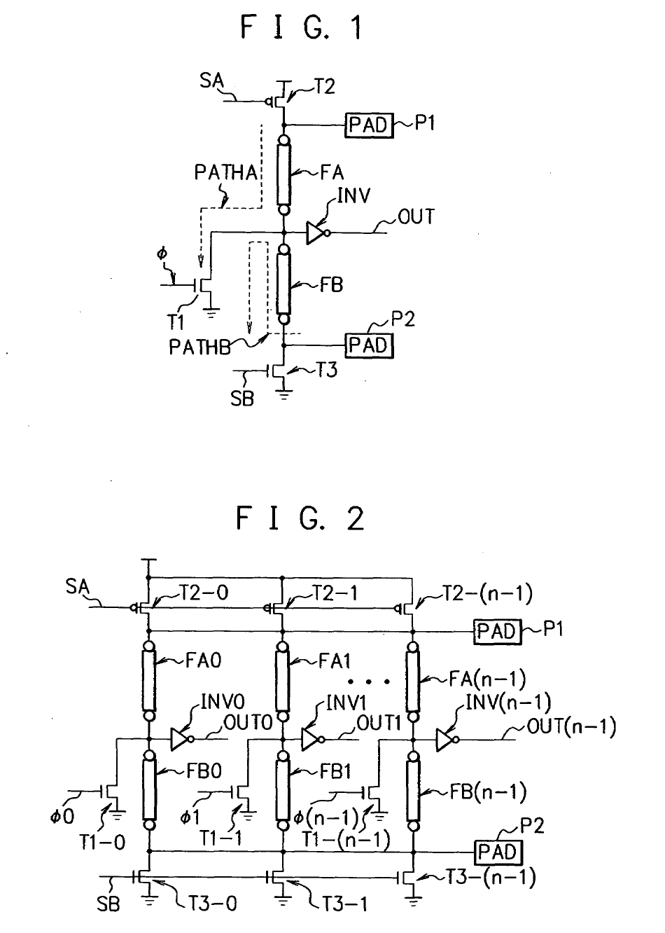

FIG. 1 is a circuit diagram showing a configuration example of a semiconductor device according to a first embodiment of the present invention.

In FIG. 1, FA and FB denote electrical fuses for recording one-bit information and the electrical fuses are comprised of, for example, polysilicon.

One end of the electrical fuse FA is connected to a power source via a P-channel MOS (Metal Oxide Semiconductor) transistor (hereinafter, referred to also as a “PMOS transistor”) T2. Concretely, the one end of the electrical fuse FA is connected to a drain of the PMOS transistor T2. A source of the PMOS transistor T2 is connected to the power source and a signal SA is supplied to a gate thereof.

One end of the electrical fuse FB is connected to reference potential (ground) via an N-channel MOS transistor (hereinafter, referred to also as a “NMOS transistor”) T3. Concretely, the one end of the electrical fuse FB is connected to a drain of the NMOS transistor T3. A source of the NMOS transistor T3 is connected to the ground and a signal SB is supplied to a gate thereof.

The other ends of the electrical fuses FA and FB are connected to each other. A junction point of the other ends of the electrical fuses FA and FB is connected to the reference potential (ground) via an NMOS transistor T1. Concretely, the other ends of the electrical fuses FA and FB are connected to a drain of the NMOS transistor T1. A source of the NMOS transistor T1 is connected to the ground and a cut selection signal φ is supplied to a gate thereof.

The transistors T1, T2, T3 are transistors used when the electrical fuses FA, FB are cut and are constituted by using high withstand voltage transistors. Here, the NMOS transistor T1 corresponds to a cutting switch in the present invention. Further, the PMOS transistor T2 and the NMOS transistor T3 correspond to a first switch and a second switch in the present invention.

The one end of the electrical fuse FA (a junction point of the one end of the electrical fuse FA and the drain of the PMOS transistor T2) is connected to a first pad P1 for supplying cutting electric current. The one end of the fuse FB (a junction point of the one end of the electrical fuse FB and the drain of the NMOS transistor T3) is connected to a second pad P2 for supplying cutting electric current.

An input end of an inverter INV is connected to the junction point of the other ends of the electrical fuses FA and FB. An output of the inverter INV is outputted as fuse cut information OUT.

In the semiconductor device shown in FIG. 1, for cutting the electrical fuse FA or FB, first, the signal SA and the signal SB are set to “H” and “L” respectively to turn off the transistors T2, T3. Consequently, the one end of the electrical fuse FA and the one end of the electrical fuse FB are disconnected from the power source and the ground respectively.

It is noted that the transistors T2, T3 are ON except during a period of a cutting operation of the electrical fuses FA and FB. That is, the one end of the electrical fuse FA is connected to the power source and the one end of the electrical fuse FB is connected to the ground except during a period of the cutting operation of the electrical fuses FA and FB.

For cutting the electric fuse FA, the transistor T1 is turned on by the cut selection signal φ and voltage is applied to the first pad P1. Consequently, the cutting electric current passes through the electrical fuse FA and the transistor T1 (a path PATHA shown by the dotted arrow in FIG. 1), so that the electrical fuse FA is cut (blown out) by migration.

For cutting the electrical fuse FB, the transistor T1 is turned on by the cut selection signal φ and voltage is applied to the second pad P2. Consequently, the cutting electric current passes through the electrical fuse FB and the transistor T1 (a path PATHB shown by the dotted arrow in FIG. 1), so that the electrical fuse FB is cut (blown out) by migration.

Here, in a case where an electrical fuse to be cut is the electrical fuse FA, the transistor T1 is turned off by the cut selection signal φ at the time of the voltage application to the second pad P2. Similarly, in a case where an electrical fuse to be cut is the electrical fuse FB, the transistor T1 is turned off by the cut selection signal φ at the time of the voltage application to the first pad P1. That is, the transistor T1 is selected to be turned on by the cut selection signal φ only when the electrical fuse is to be cut.

In the above-described manner, only one of the electrical fuses FA, FB is cut and one-bit information is recorded.

Cut information on the electrical fuses can be read by turning off the transistor T1 by the cut selection signal φ and turning on the transistors T2 and T3 by the signals SA, SB. That is, the cut information on the electrical fuses is readable while the electrical fuse FA or FB is in normal operation different from the cutting operation.

In a case where the electrical fuse FA is cut, the input of the inverter INV becomes “L”, and “H” is outputted as the fuse cut information OUT. On the other hand, in a case where the electrical fuse FB is cut, the input of the inverter INV becomes “H”, and “L” is outputted as the fuse cut information OUT.

As described above, according to the first embodiment, one of the electrical fuses is cut according to information to be recorded and the two electrical fuses FA and FB record one-bit information. This eliminates a need for a latch circuit that holds the cut information on the fuses, so that there is no risk that erroneous cut information on the fuses is outputted by erroneous latch. Accordingly, accurate cut information on the fuses can be outputted.

Moreover, owing to an extremely smaller area of the electrical fuses compared with the area of the latch circuit holding the cut information, it is possible to reduce circuit area by eliminating a need for a latch circuit. This effect gets more distinguished as the number of the mounted fuses increases. Further, there is no need to externally input a signal in order to read the cut information on the electrical fuses, which facilitates designing a chip.

FIG. 2 is a circuit diagram showing another configuration example of the semiconductor device according to the first embodiment of the present invention.

The semiconductor device shown in FIG. 2 includes a plurality of the fuse circuits shown in FIG. 1 each including one set of the electrical fuses FA, FB, the NMOS transistors T1, T3, the PMOS transistor T2, and the inverter INV, and these fuse circuits are connected in parallel. FIG. 2 shows an example where “n” pieces of the fuse circuits are connected in parallel.

Electrical fuses FAi, FBi correspond to the electrical fuses FA, FB shown in FIG. 1 respectively. Transistors T1-i, T2-i, T3-i correspond to the transistors T1, T2, T3 shown in FIG. 1 respectively. Inverters INVi correspond to the inverter INV shown in FIG. 1. “i” is a suffix and i=0 to (n−1). The electrical fuses FAi, FBi, the transistors T1-i, T2-i, T3-i, and the inverter INVi which have the same value of “i” constitute one fuse circuit.

Here, selection control signals φi are supplied to gates of the transistors T1-i respectively so that the transistors T1-i are independently controllable. On the other hand, common signals SA and SB are supplied to gates of the transistors T2-i and T3-i respectively.

Further, one-side ends of the electrical fuses FAi (junction points of the one-side ends of the electrical fuses FAi and drains of the PMOS transistors T2-i) are commonly connected to a first pad P1 for supplying cutting electric current. One-side ends of the electrical fuses FBi (junction points of the one-side ends of the electrical fuses FBi and drains of the NMOS transistors T3-i) are commonly connected to a second pad P2 for supplying cutting electric current. The other configuration is the same as that shown in FIG. 1 and therefore, description thereof will be omitted.

In the semiconductor device shown in FIG. 2, for cutting the electrical fuses FAi or FBi, first, a signal SA and a signal SB are set to “H” and “L” respectively to turn off the transistors T2-i, T3-i. For cutting the electrical fuses FAi, the transistors T1-i are turned on by the cut selection signals φi and voltage is applied to the first pad P1, whereby the electrical fuses FAi are cut. On the other hand, for cutting the electrical fuses FBi, the transistors T1-i are turned on by the cut selection signals φi and voltage is applied to the second pad P2, whereby the electrical fuses FBi are cut. At the time when the electrical fuses FAi or FBi are cut, the cut selection signals φi are controlled so that the cutting electric current passes only through the electrical fuses to be cut.

For example, for cutting the electrical fuses FA0, FA1 and the electrical fuse FB (n−1), the transistors T1-0, T1-1 are turned on by the cut selection signals φ0, φ1 and the transistor T1-(n−1) is turned off by the cut selection signal φ(n−1). Then, voltage is applied to the first pad P1. Further, the transistor T1-(n−1) is turned on by the cut selection signal φ(n−1) and the transistors T1-0, T1-1 are turned off by the cut selection signals φ0, φ1. Then, voltage is applied to the second pad P2.

The cut information on the electrical fuses is outputted in the same manner as that in the semiconductor device shown in FIG. 1 and therefore, description thereof will be omitted.

### Second Embodiment

Next, a second embodiment of the present invention will be described.

In the semiconductor device according to the first embodiment described above, since the transistors T2, T3 are ON except during the period of the cutting operation of the electrical fuses FA, FB, shoot-through current passes during operations prior to the cutting of the electrical fuses FA, FB (for example, an operation prior to a redundancy test of a memory, or the like).

Therefore, a semiconductor device according to a second embodiment of the present invention is structured so as to be capable of preventing shoot-through current from passing during the operations prior to the cutting of electrical fuses FA, FB.

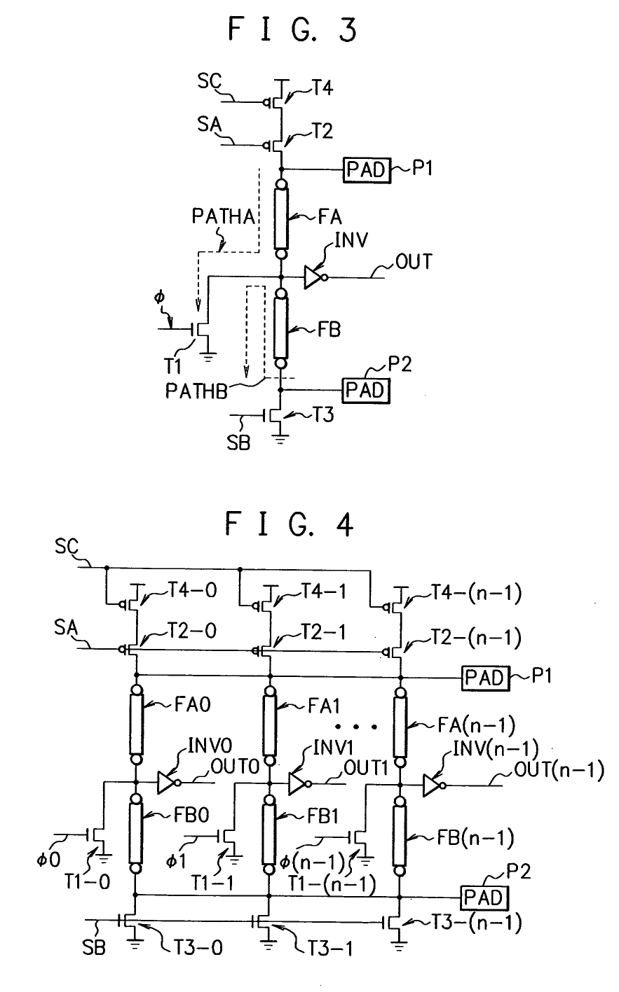

FIG. 3 is a circuit diagram showing a configuration example of the semiconductor device according to the second embodiment of the present invention. In FIG. 3, the same reference numerals and symbols are used to designate the same constituent elements as the constituent elements shown in FIG. 1 and repeated description thereof will be omitted.

The semiconductor device according to the second embodiment is different from the semiconductor device according to the first embodiment shown in FIG. 1 only in that a PMOS transistor T4 is provided between a source of a PMOS transistor T2 and a power source. Concretely, the PMOS transistor T4 has a drain connected to the source of the PMOS transistor T2 and a source connected to the power source, and a signal SC is supplied to a gate thereof. Here, the PMOS transistor T4 corresponds to a shoot-through current prevention switch in the present invention.

During the operation prior to the cutting of the electrical fuses FA, FB, the transistor T4 is kept OFF by the signal SC to disconnect the fuse circuit and the power source. The transistor T4 is constantly kept ON by the signal SC after the electrical fuses FA, FB are cut.

The cutting of the electrical fuses, the output of cut information on the electrical fuses, and so on are the same as those in the above-described first embodiment and therefore, description thereof will be omitted.

As described above, according to the second embodiment, it is possible not only to provide the same effects as those of the above-described first embodiment but also to prevent the shoot-through current from passing during the operation prior to the cutting of the electrical fuses FA, FB. This can reduce power consumption.

FIG. 4 is a circuit diagram showing another configuration example of the semiconductor device according to the second embodiment of the present invention. In FIG. 4, the same reference numerals and symbols are used to designate the same constituent elements as the constituent elements shown in FIG. 2 and repeated description thereof will be omitted.

The semiconductor device shown in FIG. 4 is structured such that PMOS transistors T4-i for shoot-through current prevention are provided in the respective fuse circuits in the semiconductor device shown in FIG. 2, as in the semiconductor device shown in FIG. 3. The PMOS transistors T4-i have drains connected to sources of PMOS transistors T2-i and sources connected to a power source, and a signal SC is commonly supplied to gates thereof.

During the operation before the electrical fuses FAi, FBi are cut, all the transistors T4-i are kept OFF by the signal SC to disconnect the fuse circuits and the power source. After the electrical fuses FAi, FBi are cut, the transistors T4-i are constantly kept ON by the signal SC.

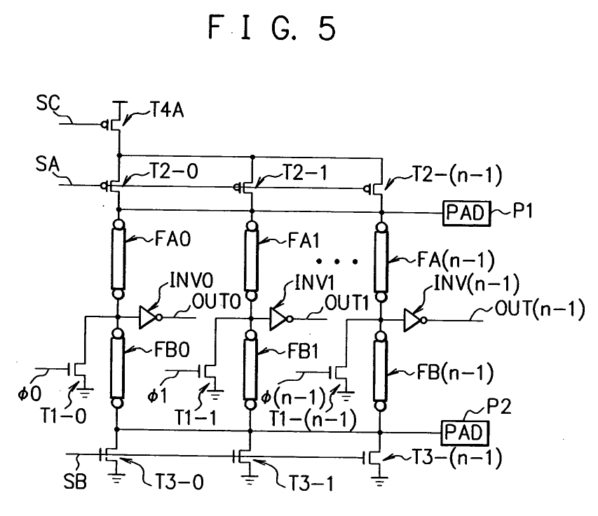

Although, in the semiconductor device shown in FIG. 4, the PMOS transistors T4-i for shoot-through current prevention are provided for the respective fuse circuits, a common PMOS transistor for shoot-through current prevention may be provided as shown in FIG. 5. FIG. 5 is a circuit diagram showing still another configuration example of the semiconductor device according to the second embodiment of the present invention. In the semiconductor device according to the second embodiment shown in FIG. 5, only one PMOS transistor T4A for shoot-through current prevention is provided for the plural fuse circuits, so that the number of circuit elements can be decreased compared with that in the configuration shown in FIG. 4, which can reduce circuit area.

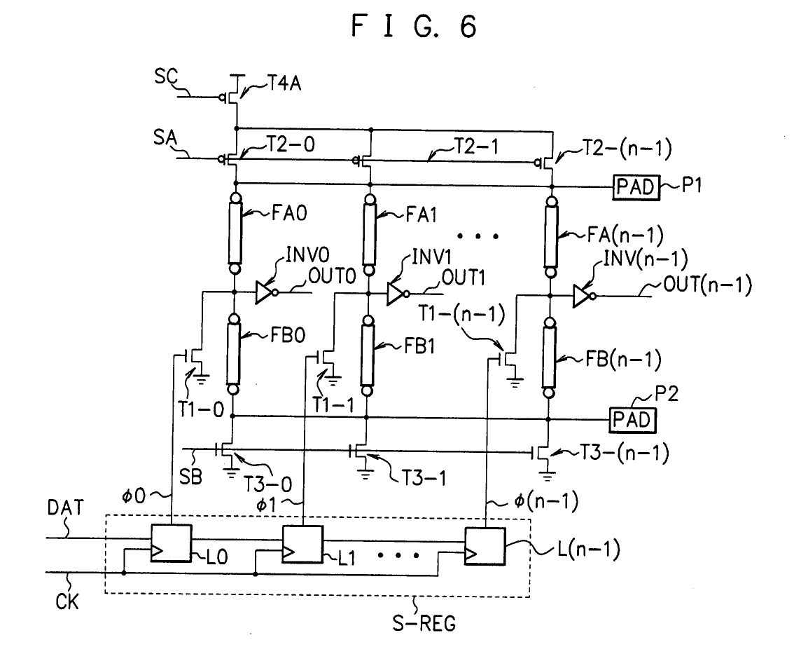

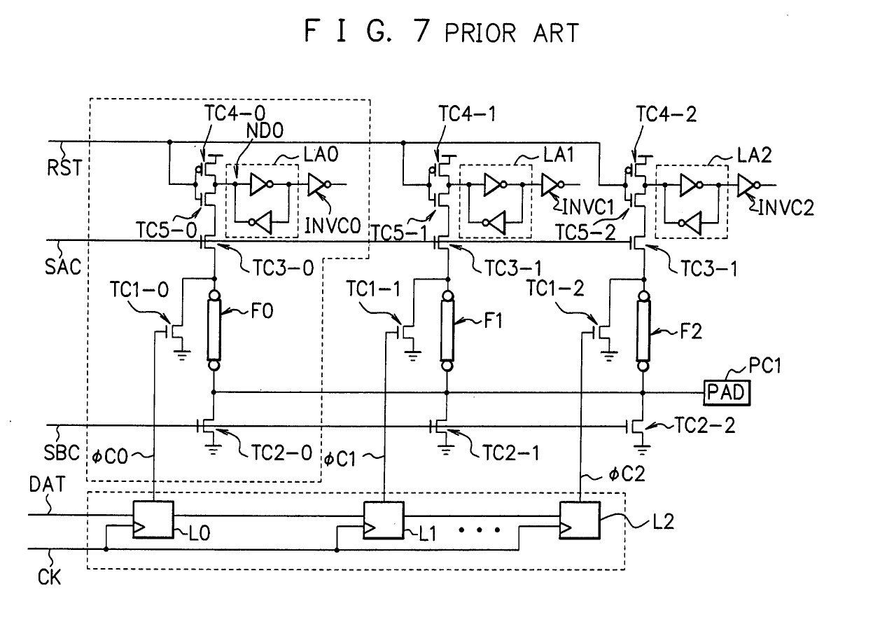

A concrete application example of the semiconductor device according to the above-described embodiments will be described based on FIG. 6. Although an example where the semiconductor device according to the second embodiment shown in FIG. 5 is applied will be described below, it should be noted that the semiconductor devices shown in FIG. 2 and FIG. 4 are similarly applicable. In FIG. 6, the same reference numerals and symbols are used to designate the same constituent elements as the constituent elements shown in FIG. 2, FIG. 4, and FIG. 5, and repeated description thereof will be omitted.

In FIG. 6, S-REG denotes a shift register in which latches Li storing data for ON/OFF control of NMOS transistors T1-i are connected in series. Serial data DAT indicating whether or not respective electrical fuses are to be cut or not are inputted to a latch L0 and are sequentially transferred by the latches Li based on a clock signal CK. Further, the latches Li output cut selection signals φi, respectively, for ON/OFF control of the NMOS transistors T1-i according to the held data.

As previously described, electrical fuses are used for recording a chip ID, redundant information of a memory (for example, a RAM or the like), and so on. The following description will be given, as an example, based on test processes actually conducted, assuming that the electrical fuses are used for recording redundant information for relieving a failure bit of a memory.

The circuit shown in FIG. 6 can record n-bit information by selectively cutting the electrical fuses in the above-described manner. Pieces of outputted fuse cut information OUT0 to OUT(n−1) are connected to the memory, and the memory is supplied with information regarding the failure bit found by the test, and based on this information, the failure bit in the memory is made redundant.

First, in order to specify a failure part of the memory, a function test is conducted. At this time, since the electric fuses FA0 to FA(n−1), FB0 to FB(n−1) are not cut, the test is conducted while the NMOS transistor T4A for shoot-through current prevention is kept OFF. This can prevent the shoot-through current from passing through the fuse circuits.

Subsequently, based on data indicating the failure part found by the test, the cutting of the electrical fuses FA0 to FA(n−1), FB0 to FB(n−1) is performed. First, the electrical fuses FAi are cut. The data DAT, which are generated based on the data indicating the failure part and indicate an electrical fuse to be cut, are sent to the serially connected latches L0 to L(n−1) constituting the shift register S-REG. According to the data DAT, the latch Li connected to the electrical fuse FAi to be cut stores “H”, and the latches Li connected to the electrical fuses FAi that do not need cutting store “L”, and they are outputted as the cut selection signals φi.

Then, after the transistors T2-0 to T2-(n−1), T3-0 to T3-(n−1) are turned off by the signals SA, SB, voltage is applied to the first pad P1. Consequently, cutting electric current passes through the electrical fuse FAi corresponding to the transistor T1-i supplied with the “H” cut selection signal φi, so that this electrical fuse FAi is cut.

Subsequently, in order to cut the electrical fuses FBi, the data DAT indicating an electrical fuse to be cut is similarly sent to the latches Li and voltage is applied to the second pad P2. Consequently, cutting electric current passes through the electrical fuse FBi corresponding to the transistor T1-i supplied with the “H” cut selection signal φi, so that this electrical fuse FBi is cut. Here, the data DAT sent to the latches Li for cutting the electrical fuse FBi is data in which bits of the data DAT sent to the latches Li for cutting the electrical fuses FAi are inverted, that is, the data DAT has a so-called back pattern of a pattern of the data DAT that is sent when the electrical fuses FAi are cut.

In a normal chip operation thereafter, the transistors T1-0 to T1-(n−1) are used while kept OFF, and the transistors T2-0 to T2-(n−1) and T3-0 to T3 (n−1) are used while kept ON. Failure information is given to the memory by the fuse cut information OUT0 to OUT(n−1) being redundant data, and the failure bit in the memory is made redundant based the failure information.

Although the NMOS transistor T1 (T1-i) is connected to the reference potential (ground) at its source in the above-described embodiments, it should be noted that this is not restrictive. Potential supplied to the source of the NMOS transistor T1 (T1-i) may be any potential that causes the cutting electric current to pass through the electrical fuses FA (FAi), FB (FBi) and the NMOS transistor T1 (T1-i) when voltage is applied to the first pad P1 and the second pad P2 in order to cut the electrical fuses.

According to the present invention, one of the electrical fuses is cut according to information to be recorded, whereby one-bit information is recorded by the two electrical fuses, which eliminates a need for a latch circuit holding cut information on the electrical fuses. This prevents erroneous fuse cut information from being outputted due to erroneous latch, so that it is possible to record and output accurate fuse cut information and to reduce circuit area.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A semiconductor device comprising:
a fuse circuit including: a first electrical fuse whose one end is connected to a first power source via a first switch; and a second electrical fuse whose one end is connected to a second power source via a second switch, the other ends of the first and second electrical fuses being connected to a third power source via a cutting switch that is selected when the electrical fuses are to be cut; and
a first pad and a second pad supplying the fuse circuit with electric current for cutting the electrical fuses,
wherein the one end of the first electrical fuse is connected to said first pad and the one end of the second electrical fuse is connected to said second pad.

2. The semiconductor device according to claim 1, further comprising an output circuit having an input end connected to the other ends of the first and second electrical fuses and outputting cut information on the first and second electrical fuses from an output end.

3. The semiconductor device according to claim 1,
wherein said fuse circuit is provided in plurality, and
wherein the one-side ends of the first electrical fuses in said plural fuse circuits are commonly connected to said first pad, and the one-side ends of the second electrical fuses in the plural fuse circuits are commonly connected to said second pad.

4. The semiconductor device according to claim 3, wherein the first electrical fuses or the second electrical fuses are selectively cut by controlling the cutting switches in said fuse circuits.

5. The semiconductor device according to claim 4, further comprising a shift register to which data regarding the electrical fuses to be cut are sequentially transferred,
wherein said shift register outputs control signals to the cutting switches in said fuse circuits according to the data.

6. The semiconductor device according to claim 1, wherein the first electrical fuse is cut by supplying cutting current from said first pad with the cutting switch closed and, and the second electrical fuse is cut by supplying cutting current from said second pad with the cutting switch closed.

7. The semiconductor device according to claim 1, further comprising a shoot-though current prevention switch connected between said fuse circuit and the first power source.

8. The semiconductor device according to claim 7,
wherein said fuse circuit is provided in plurality, and
wherein the one-side ends of the first electrical fuses in said plural fuse circuits are commonly connected to said first pad, and the one-side ends of the second electrical fuses in said plural fuse circuits are commonly connected to said second pad.

9. The semiconductor device according to claim 8, wherein said shoot-through current prevention switch is provided for each of said fuse circuits.

10. The semiconductor device according to claim 9, further comprising a shift register to which data regarding the electrical fuses to be cut are sequentially transferred and which outputs control signals to the cutting switches in said fuse circuits according to the data,
wherein the first electrical fuses or the second electrical fuses are selectively cut by controlling the cutting switches by the control signals.

11. The semiconductor device according to claim 8, wherein the single shoot-through current prevention switch is provided for said plural fuse circuits.

12. The semiconductor device according to claim 11, further comprising a shift register to which data regarding the electrical fuses to be cut are sequentially transferred and which outputs control signals to the cutting switches in said fuse circuits according to the data,
wherein the first electrical fuses or the second electrical fuses are selectively cut by controlling the cutting switches by the control signals.

13. A semiconductor device comprising:
a first switch whose one end is connected to a first power source;
a first electrical fuse whose one end is connected to the other end of said first switch;
a second electrical fuse whose one end is connected to the other end of said first electrical fuse;
a second switch whose one end is connected to the other end of said second electrical fuse and whose other end is connected to a second power source;
a third switch whose one end is connected to a junction point of the other end of said first electrical fuse and the one end of said second electrical fuse;
a first pad connected to the one end of said first electrical fuse; and
a second pad connected to the other end of said second electrical fuse.

14. The semiconductor device according to claim 13, further comprising a fourth switch whose one end is connected to the first power source,
wherein the one end of said first switch is connected to the other end of said fourth switch instead of the first power source.
